(19) United States
(12) Patent Application Publication
(10) Pub. No.: US 2026/0109468 A1
(43) Pub. Date: Apr. 23, 2026

(54) DEVICE AND PROCESS TO SET THE PHASE ON TWIN ENGINES AIRCRAFT TO ACHIEVE MINIMAL NOISE AND VIBRATION

(71) Applicants: Airbus Operations SAS, TOULOUSE (FR); Airbus Operations GmbH, HAMBURG (DE)

(72) Inventors: Martin WANDEL, HAMBURG (DE); François BESLUAU, TOULOUSE (FR); Christophe LIGU, TOULOUSE (FR); Ralf KEMME, TOULOUSE (FR); Nicolas PILON, TOULOUSE (FR); Thibaud COSTES, TOULOUSE (FR)

(21) Appl. No.: 19/361,660

(22) Filed: Oct. 17, 2025

Related U.S. Application Data
(60) Provisional application No. 63/710,950, filed on Oct. 23, 2024.

(51) Int. Cl. B64D 31/06; B64D 45/00; G10K 11/16

(52) U.S. Cl. CPC B64D 31/06; G10K 11/16; B64D 2045/0085

(57) ABSTRACT

A method for reducing a noise level and a vibration level by determining an initial noise level, determining an initial vibration level, measuring a first angular position of a first blade of a first engine based on a reference blade of the first engine, measuring a second angular position of a second blade of a second engine based on a reference blade of the second engine, calculating based on the first angular position and the second angular position a first rotational speed of the first engine and a second rotational speed of the second engine to reduce the initial noise level and the initial vibration level, transmitting the first rotational speed to the first engine and the second rotational speed to the second engine, and executing a command to set the first engine to the first rotational speed and the second engine to the second rotational speed.

### CROSS-REFERENCES TO RELATED APPLICATIONS

This application claims the benefit of the U.S. provisional patent application No. 63/710,950 filed on Oct. 23, 2024, the entire disclosure of which is incorporated herein by way of reference.

### FIELD OF THE INVENTION

This invention relates generally aircraft engine control systems, and more particularly, to systems and methods to reduce noise and vibration levels caused by aircraft engines.

### BACKGROUND OF THE INVENTION

It is known that the asynchronous operation of bladed propulsors, such as propellers and fans, on multi-engine aircraft generates acoustic cabin noise and cabin vibrations which may be annoying to passengers. Each of the propellers or fans creates airflow disturbances and beats as its blades rotate through the air flowing past the propeller or fan. Also, rotor imbalance acts on the propulsor shaft and is transmitted to and excites the aircraft structure. As a result, acoustic noise and vibrations are generated which are felt in the aircraft cabin.

The conventional method of minimizing cabin noise generated by the asynchronous operation of the bladed propulsors on multi-engine aircraft is to maintain a phase angle difference between the bladed propulsors which results in an interaction of the airflow disturbances created by the propulsors so as to at least partially cancel each other thereby reducing to varying degree the noise transmitted to the cabin. Similarly, by proper phase angle selection, interaction may be generated which results in mutual cancellation of the mechanical excitations from the imbalance in the propulsors so as to reduce cabin vibration. Typically, one propulsor is designated as the primary propulsor, and the phase angle relationship of the blades of other propulsor or propulsors, termed secondary propulsor or propulsors, as the case may be, is fixed relative to the blades of the primary propulsor to minimize cabin noise. That is, the blades of each secondary propulsor are circumferentially offset from the corresponding blades of the primary propulsor by a desired phase angle which has been determined to be that phase angle offset at which the beating noise characteristic of asynchronous operation is minimized.

Unfortunately, minimum cabin noise production and minimum cabin vibration generation are not often experienced at the same phase angle offsets between primary and secondary propulsors. The production of noise is a function of the frequency of blade passage through the air. Thus, the dominant noise pattern is a harmonic which repeats an integral number of times directly proportional to the number of blades of the propulsor. For a four blade propulsor, the minimum phase angle offset at which minimum noise will be experienced lies between 0 and 90 degrees. However, as vibration generation is a harmonic of the rotational speed of the propulsor, the phase angle offset which produces minimum vibration may lie at any value between 0 and 360 degrees.

Therefore, known methods for reducing noise and vibration levels are not modular in the sense that they only account for one variable and have inconsistent, and sometimes improper, results since only one variable (e.g., the phase angle) is accounted for.

### SUMMARY OF THE INVENTION

It is an object of the invention to provide a system and method to reduce noise levels and vibration levels in an aircraft caused by operation of the engines attached to the aircraft. Such systems and methods as disclosed herein account for acoustic, vibrational, fan blade position, and rotational speed values of the engines and the operation thereof.

To that end, there is a proposed method for reducing a noise level and a vibration level in an aircraft, the proposed method comprising determining, via at least one microphone, an initial noise level, determining, via at least one accelerometer, an initial vibration level, measuring, via a first position sensor, a first angular position of a first blade of a first engine based on a reference blade of the first engine, measuring, via a second position sensor, a second angular position of a second blade of a second engine based on a reference blade of the second engine, calculating, via an aircraft controller, based on the initial noise level, the initial vibration level, the first angular position, and the second angular position, a first rotational speed of the first engine and a second rotational speed of the second engine to reduce the initial noise level and the initial vibration level, transmitting, via the aircraft controller, the first rotational speed to the first engine and the second rotational speed to the second engine, and executing, via at least one engine controller, a command to set the first engine to the first rotational speed and the second engine to the second rotational speed.

According to a particular embodiment, the method includes measuring, via a first speed sensor on the first engine, an initial rotational speed of the first engine, and measuring, via a second speed sensor on the second engine, an initial rotational speed of the second engine measured, wherein the aircraft controller further calculates the first rotational speed and the second rotational speed based on the initial rotational speed of the first engine and the initial rotational speed of the second engine.

According to a particular embodiment, the calculating of the first rotational speed and the second rotational speed further includes determining a minimal vibration phase value by introducing a phase shift between the first engine and the second engine, the phase shift obtained by setting a testing rotational speed of the second engine higher than an initial rotational speed of the first engine until the vibration level reaches a pre-determined threshold.

According to a particular embodiment, the phase shift is based at least partly on a flight phase of the aircraft.

According to a particular embodiment, the calculating of the first rotational speed and the second rotational speed further includes determining a minimal noise phase value according to the minimal vibration phase value, the minimal noise phase value obtained by adjusting the phase shift.

According to a particular embodiment, the adjusting the phase shift includes one of shifting the phase shift up by setting the testing rotational speed of the second engine higher than the initial rotational speed of the first engine, or shifting the phase shift down by setting the testing rotational speed of the second engine lower than the initial rotational speed of the first engine.

According to a particular embodiment, the method includes setting, via the at least one engine controller, a testing rotational speed of the second engine higher than an initial rotational speed of the first engine, measuring, via the at least one accelerometer, an updated vibration level, determining, via the aircraft controller, a minimum vibration level by increasing the testing rotational speed of the second engine until the updated vibration level passes through a low vibration point where a derivative of the updated vibration level equals zero, and setting, via the at least one engine controller, an intermediate rotational speed of the first engine to the testing rotational speed of the second engine associated with the minimum vibration level.

According to a particular embodiment, the method includes measuring, via the at least one microphone, an intermediate noise level when the intermediate rotational speed of the first engine is equal to the testing rotational speed of the second engine associated with the minimum vibration level, setting, via the at least one engine controller, the testing rotational speed of the second engine lower than the intermediate rotational speed of the first engine, measuring, via the at least one microphone, an updated noise level after setting the testing rotational speed of the second engine lower than the intermediate rotational speed of the first engine, and determining, via the aircraft controller, a minimum noise level by increasing the testing rotational speed of the second engine until the updated noise level passes through a low noise point where a derivative of the updated noise level equals zero, the testing rotational speed of the second engine associated with the minimum noise level being the first rotational speed and the second rotational speed.

According to a particular embodiment, the at least one microphone is located on an external skin of the aircraft.

According to a particular embodiment, the at least one microphone is located inside a cabin of the aircraft.

According to a particular embodiment, the at least one accelerometer is located on an external skin of the aircraft.

According to a particular embodiment, the at least one accelerometer is located inside a cabin of the aircraft.

The invention also proposes an aircraft controller comprising at least one memory, computer-executable instructions that stored on the at least one memory, and a processor configured to execute the computer-executable instructions to obtain, from at least one engine controller communicatively coupled to the aircraft controller, a first angular position of a first blade of a first engine based on a reference blade of the first engine and a second angular position of a second blade of a second engine based on a reference blade of the second engine, instruct at least one microphone communicatively coupled to the aircraft controller to measure an initial noise level, instruct at least one accelerometer communicatively coupled to the aircraft controller to measure an initial vibration level, calculate, based on the first angular position, the second angular position, the initial noise level, and the initial vibration level, a first rotational speed of the first engine and a second rotational speed of the second engine to reduce the initial noise level and the initial vibration level, and transmit, to the at least one engine controller, a command to set the first engine to the first rotational speed and the second engine to the second rotational speed.

According to a particular embodiment, the processor is further configured to execute the computer executable instructions to transmit, to the at least one engine controller, a command to set a testing rotational speed higher of the second engine than an initial rotational speed of the first engine, instruct the at least one accelerometer to measure an updated vibration level, determine a minimum vibration level by commanding the testing rotational speed of the second engine to increase until the vibration level passes through a low vibration point where a derivative of the updated vibration level equals zero, and transmit, to the at least one engine controller, a command to set an intermediate rotational speed of the first engine to the testing rotational speed of the second engine associated with the minimum vibration level.

According to a particular embodiment, the processor is further configured to execute the computer executable instructions to instruct the at least one microphone to measure an intermediate noise level when the intermediate rotational speed of the first engine is equal to the testing rotational speed of the second engine associated with the minimum vibration level, transmit, to the at least one engine controller, a command to set the testing rotational speed of the second engine lower than the intermediate rotational speed of the first engine, instruct the at least one microphone to measure an updated noise level after setting the testing rotational speed of the second engine lower than the intermediate rotational speed of the first engine, and determine a minimum noise level by commanding the testing rotational speed of the second engine to increase until the updated noise level passes through a low noise point where a derivative of the updated noise level equals zero, the testing rotational speed of the second engine associated with the minimum noise level being the first rotational speed and the second rotational speed.

The invention also proposes a system comprising an aircraft controller, at least one microphone connected to the aircraft controller and configured to measure an initial noise level, at least one accelerometer connected to the aircraft controller and configured to measure an initial vibration level, a first engine including a first position sensor configured to measure a first angular position of a first blade of the first engine based on a reference blade of the first engine and a first speed sensor configured to measure an initial rotational speed of the first engine, a second engine including a second position sensor configured to measure a second angular position of a second blade of the second engine based on a reference blade of the second engine and a speed sensor configured to measure an initial rotational speed of the second engine, and at least one engine controller connected to the aircraft controller, the first engine, and the second engine, the at least one engine controller configured to obtain the first angular position and the second angular position and transmit the first angular position and the second angular position to the aircraft controller, wherein the at least one engine controller is configured to set a first rotational speed of the first engine and a second rotational speed of the second engine, wherein the aircraft controller is configured to receive the first angular position and the second angular position and determine the first rotational speed and the second rotational speed to be set by the at least one engine controller, the first rotational speed and the second rotational speed being determined to reduce the initial noise level and the initial vibration level.

According to a particular embodiment, the at least one engine controller further includes a first engine controller connected to the first engine and the aircraft controller, and a second engine controller connected to the second engine and the aircraft controller, the first engine controller and the second engine controller to separately control the first engine and the second engine respectively.

According to a particular embodiment, determining the first rotational speed and the second rotational speed to reduce the initial noise level and the initial vibration level, the system is further configured to set, via the at least one engine controller, a testing rotational speed of the second engine higher than an initial rotational speed of the first engine, measure, via the at least one accelerometer, an updated vibration level, determine, via the aircraft controller, a minimum vibration level by increasing the testing rotational speed of the second engine until the updated vibration level passes through a low vibration point where a derivative of the updated vibration level equals zero, and set, via the at least one engine controller, an intermediate rotational speed of the first engine to the testing rotational speed of the second engine associated with the minimum vibration level.

According to a particular embodiment, determining the first rotational speed and the second rotational speed to reduce the initial noise level and the initial vibration level, the system is further configured to measure, via the at least one microphone, an intermediate noise level when the intermediate rotational speed of the first engine is equal to the testing rotational speed of the second engine associated with the minimum vibration level, set, via the at least one engine controller, the testing rotational speed of the second engine lower than the intermediate rotational speed of the first engine, measure, via the at least one microphone, an updated noise level after setting the testing rotational speed of the second engine lower than the intermediate rotational speed of the first engine, and determine, via the aircraft controller, a minimum noise level by increasing the testing rotational speed of the second engine until the updated noise level passes through a low noise point where a derivative of the updated noise level equals zero, the testing rotational speed of the second engine associated with the minimum noise level being the first rotational speed and the second rotational speed.

According to a particular embodiment, the system is installed on an aircraft.

### BRIEF DESCRIPTION OF THE DRAWINGS

Embodiments of the invention are described in more detail with reference to the accompanying schematic drawings that are listed below:

FIG. 1 depicts an aircraft including a noise and vibration control system (NVCS) according to the examples provided herein.

FIG. 2 is a block diagram of the NVCS of FIG. 1.

FIG. 3 is a flowchart illustrating a process for reducing a noise level and a vibration level of a first engine and a second engine of the aircraft of FIG. 1.

FIG. 4 is a flowchart illustrating a process for calculating a rotational speed of the first engine and the second engine according to the process of FIG. 3.

FIG. 5 is a block diagram of a computing device configured to execute the process of FIG. 3.

In general, the same reference numbers will be used throughout the drawing(s) and accompanying written description to refer to the same or like parts.

### DETAILED DESCRIPTION OF THE PREFERRED EMBODIMENTS

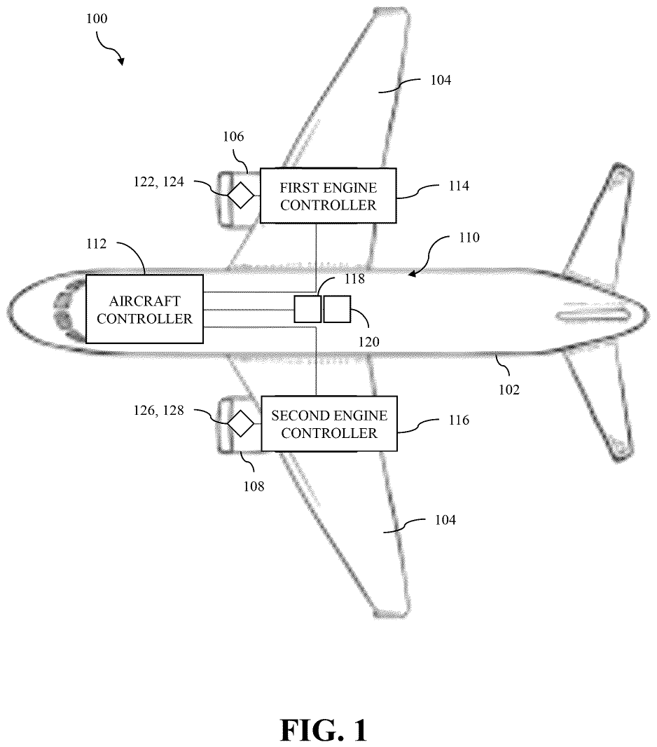

Referring to FIG. 1, an aircraft 100 is illustrated which includes a fuselage 102 and a pair of wings 104 symmetrically distributed and attached to the fuselage 102. The aircraft 100 further includes a primary engine (or a first engine) 106 and a secondary engine (or a second engine) 108. The first engine 106 and the second engine 108 each include a plurality of fan blades or propeller blades (based on whether the engines 106, 108 are turbine engines or propeller/turboprop engines). For simplicity, the plurality of fan blades or propeller blades of the first engine 106 and the second engine 108 will be generally referred to herein as a plurality of blades for each engine respectively. While only two engines are depicted in FIG. 1, it should be understood that the aircraft 100 can include more than two engines, and the associated description herein can be applied to aircraft including more than two engines.

The fuselage 102 of the aircraft 100 includes a metallic or composite external skin (generally illustrated as the surface area of the fuselage 102) surrounding a cabin compartment (not shown) which is used to house passengers and/or cargo. During operation of the aircraft 100, passengers within the cabin compartment are subjected to noise and vibration associated with operation of the aircraft, including but not limited to, operation of the first engine 106 and the second engine 108.

The aircraft 100 includes a noise and vibration control system (NVCS) 110 for monitoring and adjusting operating parameters of the first engine 106 and the second engine 108 to reduce a noise level and a vibration level experienced within a cabin of the aircraft 100 by passengers. The NVCS 110 includes an aircraft controller 112, a first engine controller 114, and a second engine controller 116.

The aircraft controller 112 collects parameters from the first engine controller 114 and the second engine controller 116 and calculates the operational parameters to adjust the first engine 106 and the second engine 108. In the examples disclosed herein, the parameters collected by the aircraft controller 112 include an angular position of a fan blade of each engine 106, 108, a rotational speed of each engine 106, 108, a noise level, and a vibration level.

The aircraft 100 of FIG. 1 includes an accelerometer 118 for measuring the vibration level and a microphone 120 for measuring the noise level. In the examples provided herein, the accelerometer 118 and the microphone 120 can both be, or individually placed, within either the external skin of the aircraft 100 or within the cabin compartment of the aircraft 100 (e.g., both placed in the same spot, or both placed in different spots). In some examples, the accelerometer 118 and the microphone 120 are placed along a longitudinal axis of the aircraft 100 (e.g., along an axis extending from a nose of the aircraft 100 to a tail of the aircraft 100). Further, in some examples, the microphone 120 is placed on an external skin passenger floor of the fuselage 102 of the aircraft 100 (e.g., along an underside of the aircraft 100).

In the example of FIG. 1, the first engine 106 includes a first position sensor 122 and a first speed sensor 124 (both sensors are illustrated by the same reference block, but it should be understood that the sensors can be separate). The first position sensor 122 measures a first angular position (e.g., in radians or degrees) of a first blade of the plurality of blades of the first engine 106 based on a reference blade of the first engine 106. In some examples, the reference blade of the first engine 106 is a position of one of the plurality of blades of the first engine 106 at a vertical high point (e.g., a 12 o'clock position). The first speed sensor 124 of the first engine 106 measures a rotational speed (e.g., in radians per second or degrees per second) of the first engine 106.

Further to the example of FIG. 1, the second engine 108 likewise includes a second position sensor 126 and a second speed sensor 128. Similarly, the second position sensor 126 measures a second angular position (e.g., in radians or degrees) of a second blade of the plurality of blades of the second engine 108 based on a reference blade of the second engine 108. In some examples, the reference blade of the second engine 108 is a position of one of the plurality of blades of the second engine 108 at a vertical high point (e.g., a 12 o'clock position). The second speed sensor 128 of the second engine 108 measures a rotational speed (e.g., in radians per second or degrees per second) of the second engine 108.

In the examples disclosed herein, the difference between the first angular position of the first engine 106 and the second angular position of the second engine 108 is referred to as a phase. When the first engine 106 and the second engine 108 are in operation, a noise is generated by each blade of the plurality of blades. By adjusting the phase, a setting may be achieved to minimize the noise of the plurality of blades interacting together. This minimal noise phase value may repeat along the cycle on as many sectors as blades disposed on the engines 106, 108.

Further, even if the setting to achieve a minimum noise is obtained, when the first engine 106 and the second engine 108 are in operation, there is still a little unbalance of each of the plurality of blades that generates vibrations. The phase of first engine 106 and the second engine 108 may be synchronized so that vibration is minimized.

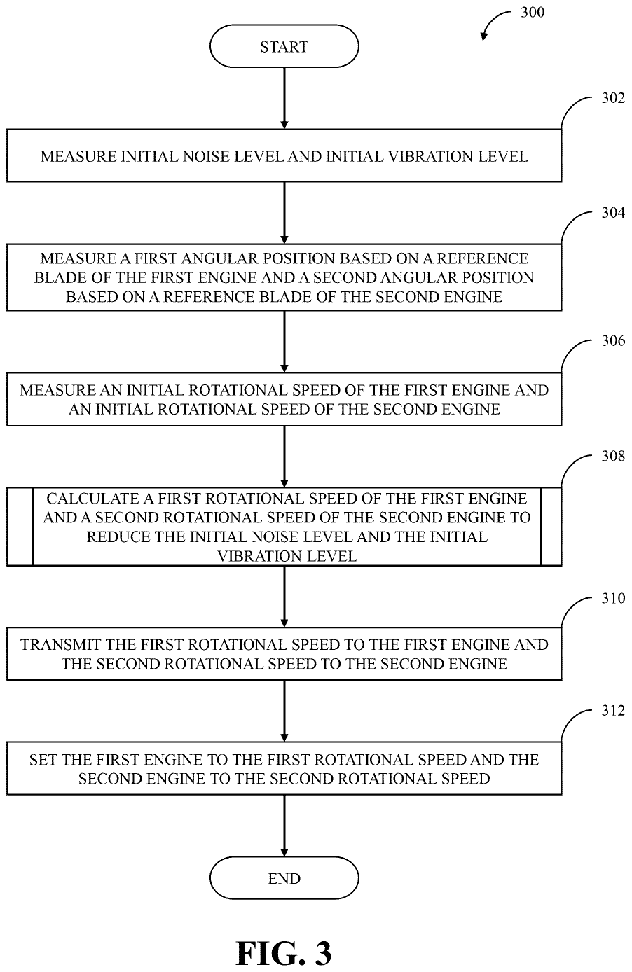

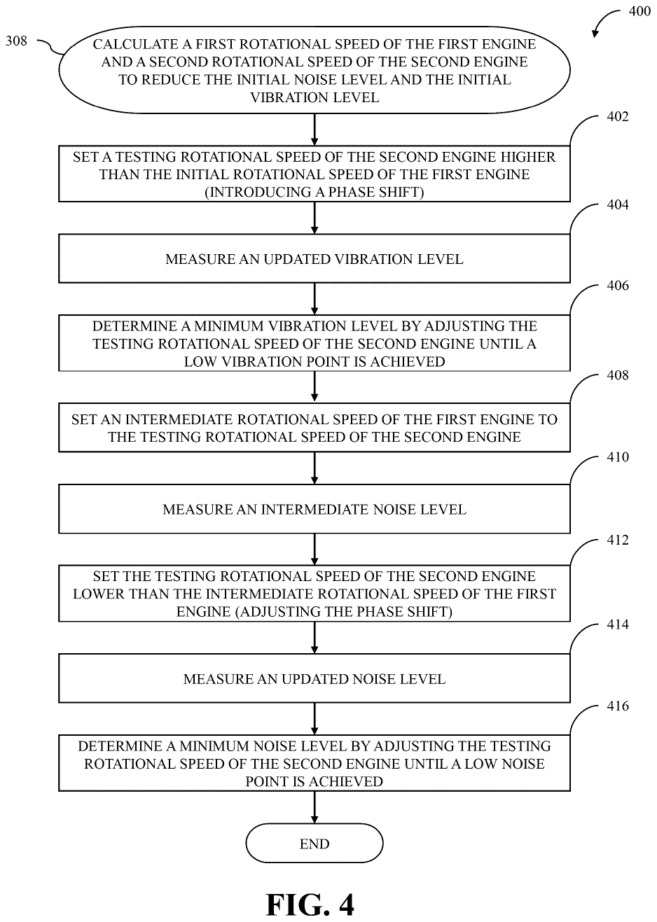

The process for reducing and/or minimizing the noise level and the vibration level of the first engine 106 and the second engine 108, operating together in tandem, is described herein with reference to FIGS. 3-4.

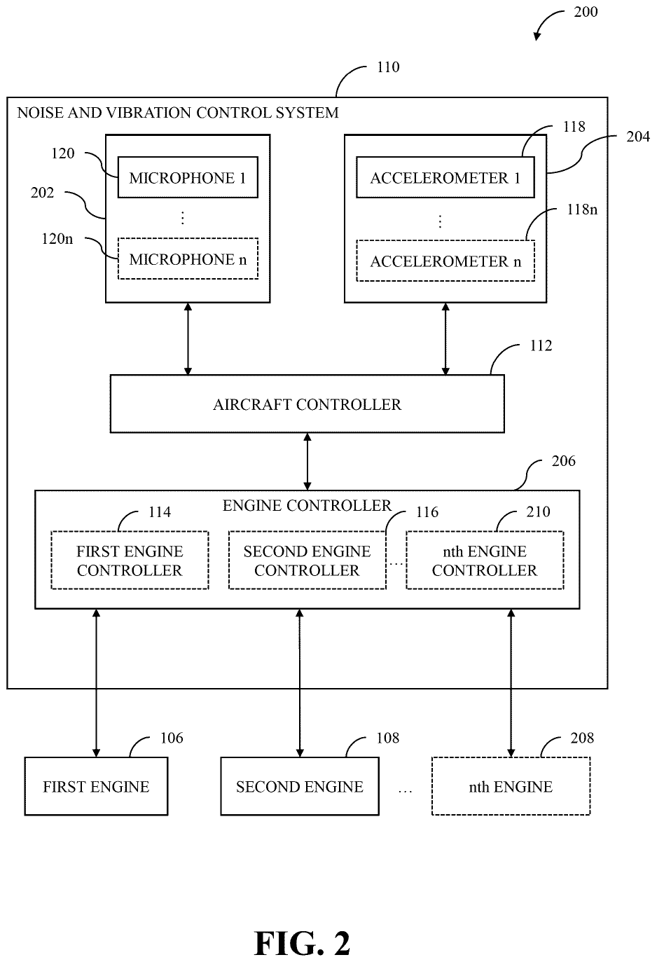

FIG. 2 is a block diagram of the NVCS 110 of FIG. 1. The NVCS 110 includes a microphone array 202, an accelerometer array 204, an engine controller 206, and the aircraft controller 112. In the example of FIG. 2, the microphone array 202, the accelerometer array 204, and the engine controller 206 are in communication with the aircraft controller 112.

As shown in FIG. 2, the first engine 106 and the second engine 108 are in communication with the engine controller 206. In some examples, there is one engine controller that manages all engines on the aircraft 100. In the examples provided herein, the engine controller 206 includes the first engine controller 114 and the second engine controller 116, such that the first engine 106 is in communication with the first engine controller 114 and the second engine 108 is in communication with the second engine controller 116. In further examples, more than two engines can be present on the aircraft 100, such that an nth engine 208 is also in communication with the engine controller 206. In such examples, the engine controller 206 includes an nth engine controller 210, with which the nth engine 208 is in communication with. It should be understood that for every engine present on the aircraft 100, there could also be one engine controller for each engine present, and the disclosure herein is not limited to just one or two engine controllers.

The microphone array 202 of FIG. 2 includes at least one microphone (e.g., the microphone 120 of FIG. 1). In some examples, the microphone array 202 includes more than one microphone 120n. In the examples provided herein, more than one microphone may be used to compare and/or validate noise level measurements to ensure that the first engine 106 and the second engine 108 are set to the appropriate rotational speeds to reduce the noise level and the vibration level as much as possible. Therefore, while the examples provided herein include one microphone (e.g., the microphone 120), it should be understood that more than one microphone may be present.

The accelerometer array 204 of FIG. 2 includes at least one accelerometer (e.g., the accelerometer 118 of FIG. 1). In some examples, the accelerometer array 204 includes more than one accelerometer 118n. In the examples provided herein, similar to that of the microphone array 202, more than one accelerometer may be used to compare and/or validate vibration level measurements to ensure that the first engine 106 and the second engine 108 are set to the appropriate rotational speeds to reduce the noise level and the vibration level as much as possible. Therefore, while the examples provided herein include one accelerometer (e.g., the accelerometer 118), it should be understood that more than one accelerometer may be present.

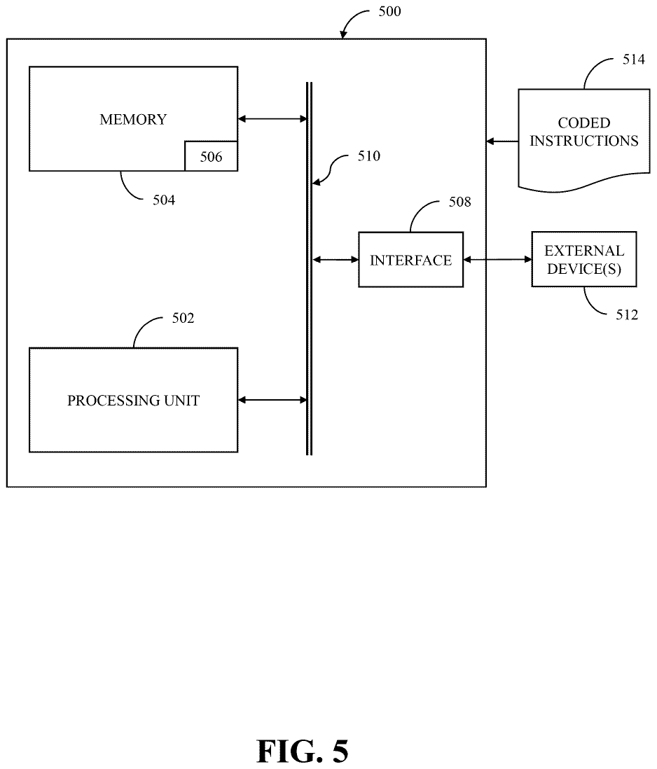

The aircraft controller 112 and the engine controller 206 (including all sub-level engine controllers such as the first engine controller 114 and the second engine controller 116) include processing circuitry and/or a processing unit configured to execute the processes of FIGS. 2-3 accordingly. Example processing circuitry and/or the processing unit is exemplified herein with reference to FIG. 5.

FIG. 3 is a flowchart illustrating a noise and vibration reduction process 300 for reducing a noise level and a vibration level of a first engine 106 and a second engine 108 of the aircraft 100 of FIG. 1.

At block 302, the microphone 120 measures an initial noise level and the accelerometer 118 measures an initial vibration level. In the examples provided herein, the initial noise level and the initial vibration level are initial readings/measurements at a time in which the aircraft controller 112 decides that a reduction in the noise level and the vibration level is desired. Such a decision could be determined based on passenger comfort levels, warnings issued by flight displays in the aircraft 100, etc.

At block 304, the first position sensor 122 measures the first angular position of the first blade of the first engine 106 based on the reference blade of the first engine 106. Also at block 304, the second position sensor 126 measures the second angular position of the second blade of the second engine 108 based on the reference blade of the second engine 108. As stated above, the difference between the first angular position and the second angular position is the phase.

At block 306, the first speed sensor 124 measures an initial rotational speed of the first engine 106 and the second speed sensor 128 measures an initial rotational speed of the second engine 108. In the examples provided herein, the initial rotational speed of the first engine 106 and the initial rotational speed of the second engine 108 are used to initialize a starting analysis of the noise level and the vibration level, and is further used to determine how much the rotational speeds should change to achieve the desired noise level and vibration level.

At block 308, the aircraft controller 112 calculates the first rotational speed of the first engine 106 and the second rotational speed of the second engine 108 to achieve the desired, reduced noise level and vibration level. In some examples, the calculation of the first rotational speed and the second rotational speed is based on the first angular position and the second angular position. In other examples, the calculation is based on the first angular position, the second angular position, the initial noise level, the initial vibration level, the initial rotational speed of the first engine 106, the initial rotational speed of the second engine 108, and/or any other relevant parameter. Further details regarding the calculation of block 308 is given with reference to FIG. 4.

Once the aircraft controller 112 calculates the first rotational speed and the second rotational speed to reduce the noise level and the vibration level, the aircraft controller 112, at block 310, transmits the first rotational speed to the first engine controller 114 and the second rotational speed to the second engine controller 116.

At block 312, the first engine controller 114 sets the first engine 106 to the first rotational speed and the second engine controller 116 sets the second engine 108 to the second rotational speed. In examples where there is only one engine controller (e.g., the engine controller 206) controlling multiple engines, the engine controller 206 sets the appropriate engine to the appropriate rotational speed.

FIG. 4 is a flowchart illustrating a rotational speed calculation process 400 for calculating a rotational speed of the first engine 106 and the second engine 108 according to block 308 of FIG. 3.

At block 402, the aircraft controller 112, through a command to the second engine controller 116, sets a testing rotational speed of the second engine 108 higher than the initial rotational speed of the first engine 106 measured according to block 306 of FIG. 3, thereby introducing a phase shift between the first engine 106 and the second engine 108. In some examples, the phase shift introduced is based at least partly on a flight phase of the aircraft 100 (e.g., taxi, takeoff, climb, cruise, etc.).

At block 404, the aircraft controller 112, through a command to the accelerometer 118, receives an updated vibration level according to the phase shift introduced at block 402.

At block 406, the testing rotational speed of the second engine 108 is adjusted until a minimum vibration level is achieved. According to the examples herein, blocks 402 - 406 are repeated until a low vibration point is achieved, such that the testing rotational speed is set, the updated vibration level is measured, and a determination is made by the aircraft controller 112 as to whether the low vibration point is achieved. If the low vibration point is not achieved, then the testing rotational value is set to a new speed and the process repeats. In the examples disclosed herein, the low vibration point is achieved when a derivative (e.g., a rate of change) of the updated vibration level reaches zero. In some examples, the minimum vibration level is also referred to as a minimal vibration phase value of the first engine 106 and the second engine 108.

Once the low vibration point is achieved according to the aircraft controller 112, at block 408, the aircraft controller 112 sets an intermediate rotational speed of the first engine 106 to the testing rotational speed of the second engine 108 corresponding to the minimum vibration level. At this point, the rotational speeds of the first engine 106 and the second engine 108 are the same and correspond to the minimum vibration level.

At block 410, the aircraft controller 112, through a command to the microphone 120, receives an intermediate noise level corresponding to the minimum vibration level.

At block 412, the aircraft controller 112, through a command to the second engine controller 116, sets the testing rotational speed of the second engine 108 lower than the intermediate rotational speed of the first engine 106. In this step, the phase shift is adjusted, either up by setting the testing rotational speed of the second engine 108 higher than the intermediate rotational speed of the first engine 106 (or the initial rotational speed of the first engine 106 if performed during blocks 402 - 406), or down by setting the testing rotational speed of the second engine 108 lower than the intermediate rotational speed of the first engine 106 (or the initial rotational speed of the first engine 106 if performed during blocks 402 - 406). In the example of FIG. 4, the testing rotational speed of the second engine 108 is set lower than the intermediate rotational speed of the first engine 106.

At block 414, the aircraft controller 112, through a command to the microphone 120, receives an updated noise level according to the adjusted phase shift introduced at block 412.

At block 416, the testing rotational speed of the second engine 108 is adjusted until a minimum noise level is achieved. According to the examples herein, blocks 412 - 416 are repeated until a low noise point is achieved, such that the testing rotational speed is set, the updated noise level is measured, and a determination is made by the aircraft controller 112 as to whether the low noise point is achieved. If the low noise point is not achieved, then the testing rotational value is set to a new speed and the process repeats. In the examples disclosed herein, the low noise point is achieved when a derivative (e.g., a rate of change) of the updated noise level reaches zero.

Once the minimum noise level is achieved, the testing rotational speed of the second engine 10 8 corresponding to said minimum noise level is the first rotational speed and the second rotational speed to reduce the initial noise level and the initial vibration level. Therefore, the aircraft controller 112 transmits the first rotational speed to the first engine 106 and the second rotational speed to the second engine 108 according to the process of block 310 above, such that the first rotational speed and the second rotational speed are equal to the testing rotational speed of the second engine 108 corresponding to the minimum noise level.

In the examples disclosed herein, the testing rotational speed of the second engine 108, the intermediate rotational speed of the first engine 106, and the intermediate noise level are merely terms used to define a non-static, changing variable of the rotational speeds of the engines 106, 108 accordingly. Further, it should be understood that any of the aforementioned process steps can be rearranged and substituted accordingly to achieve the reduced noise level and vibration level.

FIG. 5 is a block diagram of a computing device 500 configured to execute the processes of FIG. 3 and FIG. 4. The computing device 500 includes a processing unit 502, at least one memory 504, computer-executable instructions 506, and an interface 508. The processing unit 502 (or processing circuitry) communicates with the memory 504 and the interface 508 via a bus 510 configured to handle communication of data between the aforementioned components. The interface 508 is in communication, either wired or wirelessly, with one or more external devices 512. Examples of the one or more external devices 512 include flight displays, flight controls, fully-automated digital engine controller(s) (FADECs), and/or any other suitable device.

The systems and devices described herein (e.g., the aircraft controller 112, the first engine controller 114, the second engine controller 116, and the engine controller 206) may include a controller or the computing device 500 comprising the processing unit 502 and the memory 504 which has stored therein the computer-executable instructions 506 for implementing the processes described herein. The processing unit 502 may comprise any suitable devices configured to cause a series of steps to be performed so as to implement the method such that instructions, when executed by the computing device 500 or other programmable apparatus, may cause the functions/acts/steps specified in the methods described herein to be executed. The processing unit 502 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 504 may be any suitable known or other machine-readable storage medium. The memory 504 may comprise non-transitory computer readable storage medium such as, for example, but not limited to, an electronic, magnetic, optical, electromagnetic, infrared, or semiconductor system, apparatus, or device, or any suitable combination of the foregoing. The memory 504 may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory 504 may comprise any storage means (e.g., devices) suitable for retrievably storing the computer-executable instructions 506 executable by processing unit 502. It should be understood that more than one memory 504 can be present in the computing device 500.

The methods and systems described herein may be implemented in a high-level procedural or object-oriented programming or scripting language, or a combination thereof, to communicate with or assist in the operation of the controller or computing device 500. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. In some examples, the program code may be delivered via coded instructions 514, which can be in the form of any of the aforementioned storage media of device. The program code may be readable by a general or special-purpose programmable computer for configuring and operating the computer when the storage media or device is read by the computer to perform the procedures described herein.

The computer-executable instructions 506 may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

What is claimed is:

1. A method for reducing a noise level and a vibration level in an aircraft, the method comprising:
determining, via at least one microphone, an initial noise level;
determining, via at least one accelerometer, an initial vibration level;
measuring, via a first position sensor, a first angular position of a first blade of a first engine based on a reference blade of the first engine;
measuring, via a second position sensor, a second angular position of a second blade of a second engine based on a reference blade of the second engine;
calculating, via an aircraft controller, based on the initial noise level, the initial vibration level, the first angular position, and the second angular position, a first rotational speed of the first engine and a second rotational speed of the second engine to reduce the initial noise level and the initial vibration level;
transmitting, via the aircraft controller, the first rotational speed to the first engine and the second rotational speed to the second engine; and
executing, via at least one engine controller, a command to set the first engine to the first rotational speed and the second engine to the second rotational speed.

2. The method of claim 1, further comprising:
measuring, via a first speed sensor on the first engine, an initial rotational speed of the first engine; and
measuring, via a second speed sensor on the second engine, an initial rotational speed of the second engine measured;
wherein the aircraft controller further calculates the first rotational speed and the second rotational speed based on the initial rotational speed of the first engine and the initial rotational speed of the second engine.

3. The method of claim 1, wherein the calculating of the first rotational speed and the second rotational speed further includes determining a minimal vibration phase value by introducing a phase shift between the first engine and the second engine, the phase shift obtained by setting a testing rotational speed of the second engine higher than an initial rotational speed of the first engine until the vibration level reaches a pre-determined threshold.

4. The method of claim 3, wherein the phase shift is based at least partly on a flight phase of the aircraft.

5. The method of claim 3, wherein the calculating of the first rotational speed and the second rotational speed further includes determining a minimal noise phase value according to the minimal vibration phase value, the minimal noise phase value obtained by adjusting the phase shift.

6. The method of claim 5, wherein adjusting the phase shift includes one of:
shifting the phase shift up by setting the testing rotational speed of the second engine higher than the initial rotational speed of the first engine; or
shifting the phase shift down by setting the testing rotational speed of the second engine lower than the initial rotational speed of the first engine.

7. The method of claim 1, further comprising:
setting, via the at least one engine controller, a testing rotational speed of the second engine higher than an initial rotational speed of the first engine;
measuring, via the at least one accelerometer, an updated vibration level;
determining, via the aircraft controller, a minimum vibration level by increasing the testing rotational speed of the second engine until the updated vibration level passes through a low vibration point where a derivative of the updated vibration level equals zero; and
setting, via the at least one engine controller, an intermediate rotational speed of the first engine to the testing rotational speed of the second engine associated with the minimum vibration level.

8. The method of claim 7, further comprising:
measuring, via the at least one microphone, an intermediate noise level when the intermediate rotational speed of the first engine is equal to the testing rotational speed of the second engine associated with the minimum vibration level;
setting, via the at least one engine controller, the testing rotational speed of the second engine lower than the intermediate rotational speed of the first engine;
measuring, via the at least one microphone, an updated noise level after setting the testing rotational speed of the second engine lower than the intermediate rotational speed of the first engine; and
determining, via the aircraft controller, a minimum noise level by increasing the testing rotational speed of the second engine until the updated noise level passes through a low noise point where a derivative of the updated noise level equals zero, the testing rotational speed of the second engine associated with the minimum noise level being the first rotational speed and the second rotational speed.

9. The method of claim 1, wherein the at least one microphone is located on an external skin of the aircraft.

10. The method of claim 1, wherein the at least one microphone is located inside a cabin of the aircraft.

11. The method of claim 1, wherein the at least one accelerometer is located on an external skin of the aircraft.

12. The method of claim 1, wherein the at least one accelerometer is located inside a cabin of the aircraft.

13. An aircraft controller comprising:
at least one memory;
computer-executable instructions that stored on the at least one memory; and
a processor configured to execute the computer-executable instructions to:
obtain, from at least one engine controller communicatively coupled to the aircraft controller, a first angular position of a first blade of a first engine based on a reference blade of the first engine and a second angular position of a second blade of a second engine based on a reference blade of the second engine;
instruct at least one microphone communicatively coupled to the aircraft controller to measure an initial noise level;
instruct at least one accelerometer communicatively coupled to the aircraft controller to measure an initial vibration level;
calculate, based on the first angular position, the second angular position, the initial noise level, and the initial vibration level, a first rotational speed of the first engine and a second rotational speed of the second engine to reduce the initial noise level and the initial vibration level; and
transmit, to the at least one engine controller, a command to set the first engine to the first rotational speed and the second engine to the second rotational speed.

14. The aircraft controller of claim 13, wherein the processor is further configured to execute the computer executable instructions to:
transmit, to the at least one engine controller, a command to set a testing rotational speed higher of the second engine than an initial rotational speed of the first engine;
instruct the at least one accelerometer to measure an updated vibration level;
determine a minimum vibration level by commanding the testing rotational speed of the second engine to increase until the vibration level passes through a low vibration point where a derivative of the updated vibration level equals zero; and
transmit, to the at least one engine controller, a command to set an intermediate rotational speed of the first engine to the testing rotational speed of the second engine associated with the minimum vibration level.

15. The aircraft controller of claim 14, wherein the processor is further configured to execute the computer executable instructions to:
instruct the at least one microphone to measure an intermediate noise level when the intermediate rotational speed of the first engine is equal to the testing rotational speed of the second engine associated with the minimum vibration level;
transmit, to the at least one engine controller, a command to set the testing rotational speed of the second engine lower than the intermediate rotational speed of the first engine;
instruct the at least one microphone to measure an updated noise level after setting the testing rotational speed of the second engine lower than the intermediate rotational speed of the first engine; and
determine a minimum noise level by commanding the testing rotational speed of the second engine to increase until the updated noise level passes through a low noise point where a derivative of the updated noise level equals zero, the testing rotational speed of the second engine associated with the minimum noise level being the first rotational speed and the second rotational speed.

16. A system comprising:
an aircraft controller;
at least one microphone connected to the aircraft controller and configured to measure an initial noise level;
at least one accelerometer connected to the aircraft controller and configured to measure an initial vibration level;
a first engine including:
a first position sensor configured to measure a first angular position of a first blade of the first engine based on a reference blade of the first engine; and
a first speed sensor configured to measure an initial rotational speed of the first engine;
a second engine including:
a second position sensor configured to measure a second angular position of a second blade of the second engine based on a reference blade of the second engine; and
a speed sensor configured to measure an initial rotational speed of the second engine; and
at least one engine controller connected to the aircraft controller, the first engine, and the second engine, the at least one engine controller configured to obtain the first angular position and the second angular position and transmit the first angular position and the second angular position to the aircraft controller, wherein the at least one engine controller is configured to set a first rotational speed of the first engine and a second rotational speed of the second engine;
wherein the aircraft controller is configured to receive the first angular position and the second angular position and determine the first rotational speed and the second rotational speed to be set by the at least one engine controller, the first rotational speed and the second rotational speed being determined to reduce the initial noise level and the initial vibration level.

17. The system of claim 16, wherein the at least one engine controller further includes a first engine controller connected to the first engine and the aircraft controller, and a second engine controller connected to the second engine and the aircraft controller, the first engine controller and the second engine controller to separately control the first engine and the second engine respectively.

18. The system of claim 16, wherein to determine the first rotational speed and the second rotational speed to reduce the initial noise level and the initial vibration level, the system is further configured to:
set, via the at least one engine controller, a testing rotational speed of the second engine higher than an initial rotational speed of the first engine;
measure, via the at least one accelerometer, an updated vibration level;
determine, via the aircraft controller, a minimum vibration level by increasing the testing rotational speed of the second engine until the updated vibration level passes through a low vibration point where a derivative of the updated vibration level equals zero; and
set, via the at least one engine controller, an intermediate rotational speed of the first engine to the testing rotational speed of the second engine associated with the minimum vibration level.

19. The system of claim 18, wherein to determine the first rotational speed and the second rotational speed to reduce the initial noise level and the initial vibration level, the system is further configured to:
measure, via the at least one microphone, an intermediate noise level when the intermediate rotational speed of the first engine is equal to the testing rotational speed of the second engine associated with the minimum vibration level;
set, via the at least one engine controller, the testing rotational speed of the second engine lower than the intermediate rotational speed of the first engine;
measure, via the at least one microphone, an updated noise level after setting the testing rotational speed of the second engine lower than the intermediate rotational speed of the first engine; and
determine, via the aircraft controller, a minimum noise level by increasing the testing rotational speed of the second engine until the updated noise level passes through a low noise point where a derivative of the updated noise level equals zero, the testing rotational speed of the second engine associated with the minimum noise level being the first rotational speed and the second rotational speed.

20. The system of claim 16, wherein the system is installed on an aircraft.
